(19) United States
(12) Patent Application Publication
(10) Pub. No.: US 2003/0058737 A1
(43) Pub. Date: Mar. 27, 2003

(54) Mixer/flow conditioner

(76) Inventors: Jonathan Dwight Berry, Meriden, CT (US); Gilbert Otto Kraemer, North Haven, CT (US)

Correspondence Address: McCormick, Paulding & Huber, City Place II, 185 Asylum Street, Hartford, CT, 06103-3402, US

(21) Appl. No.: 09/963,778

(22) Filed: Sep. 25, 2001

(51) Int. Cl. B01F 5/06

(52) U.S. Cl. 366/340

(57) ABSTRACT

The invention is a mixer/flow conditioner wherein the orientation of the passages are such that an initial flow stream passing is divided into a plurality of packets with each packet being given a velocity component such that angular momenta of the packets exiting the passages sums to approximately zero thereby achieving a final flow stream having a swirl number less than 0.2 and possibly as low as 0.03. The invention has particular application in mixing and/or flow conditioning where a recirculation zone is not desired.

This invention was made with U.S. government support under NASA Contract Number NA53-97-013. The U.S. government has certain rights in this invention.

### FIELD OF THE INVENTION

The present invention is generally directed to mixing two fluids to form a flow stream having a high degree of turbulence, and more specifically to a mixer/flow conditioner for use in a gas turbine to mix a fuel and air mixture prior to combustion of the mixture within the gas turbine.

### BACKGROUND OF THE INVENTION

The present invention has general utility with respect to flow channels and flow streams flowing within the flow channel and is particularly useful in gas turbines where a fuel and air are mixed prior to entering a combustion zone. However, while the present invention is described and illustrated in the context of a gas turbine, it should be understood that the invention is not limited in this regard as the invention has applications such as in fluid flow measurement.

Within a gas turbine having a combustion zone, it is common to mix fuel and air immediately upstream thereof. Generally, the fuel and air must be mixed rapidly and sufficiently to produce a flow stream suitable for combustion in the combustion zone. Current mixing methods rely on swirlers that impart significant angular momentum to and turbulence in the flow stream to produce a suitable fuel/air mixture. However, these swirlers also produce strong recirculation zones within the flow stream downstream of the swirler and upstream of the combustion zone. This is not desirable since the recirculation zone could potentially support an autoignition event or act as a flame holder, causing a flame to exist upstream of the combustion zone. A flame in this area could cause catastrophic damage to the gas turbine, as this area of the gas turbine is not designed to withstand the temperatures such a flame would produce.

A flame existing in this area when a recirculation zone is present becomes increasingly more likely as the flow stream, which is already lean, is made ever leaner to comply with environmental regulations. More specifically, to meet current pollution restrictions fuel and air mixtures used by gas turbines have become progressively leaner in an effort to have flames that burn at lower temperatures. These lower flame temperatures equate to lower emissions of various regulated green house gases. While these leaner flames are stable within the combustion zone when the gas turbine is at full load, these flames must be made leaner when less than full load conditions are required, during turndown. During turndown, the flame within the combustion zone can become unstable and potentially flashback upstream, toward the fuel source. If a recirculation zone is present upstream, the flame may stabilize at the location of the recirculation zone.

Another potential problem caused by a recirculation zone in close proximity to the swirler is that the recirculation zone may permit an autoignition event, e.g., a flame. Autoignition occurs because the fuel and air mixture is of the proper proportions and the flow conditions of the flow stream containing the fuel and air mixture permit the autoignition to occur. A recirculation zone provides the proper flow conditions by locally slowing the flow and giving the flame a place to anchor.

While it is an objective of the device to mix two fluids to create a mixed flow stream without creating a recirculation zone, a second application for the present invention is to create a conditioned flow stream from an existing flow stream without a recirculation zone. The primary difference between mixing and flow condition being that mixing involves the bringing together of two or more independent flow streams while flow conditioning involves modifying an existing flow stream.

The existence and degree of recirculation in a flow stream is characterized by a swirl number. Swirl number is a nondimensional criterion characterizing the amount of rotation imparted to an axial flow. For a flow stream passing through a device that will impart a swirl, the flow stream has an axial flux of angular momentum and an axial thrust, and the device defines a diameter. The swirl number is equal to two times the axial flux of angular momentum divided by the product of the axial thrust and the swirler diameter.

As those skilled in the art of mixing/flow conditioning realize, to have a swirl sufficient enough to create a recirculation zone suitable for supporting an autoignition event or flame holding, the swirl number of the flow stream must be greater than about 0.6. Swirl numbers less than 0.2 are considered to indicate that there is insufficient recirculation present to support autoignition or flame holding. While swirl numbers of below 0.03 indicate a conditioned flow.

### SUMMARY OF THE INVENTION

The present invention is directed in one aspect to a mixer/flow conditioner that includes at least three successive partitions defining at least two gaps therebetween. Means are provided within each gap that define a plurality of passages between each pair of successive partitions. At least one passage in each gap is oriented to impart a tangential velocity component to a fluid, hereinafter referred to as a packet, passing therethrough. The at least one passages in each gap cooperating with the packet passing therethrough to convert an initial flow stream into a final flow stream having a swirl number less than about 0.2.

Mixing, and/or flow conditioning, in the present invention is accomplished by subdividing the initial flow stream entering the mixer/flow conditioner into numerous packets as the initial flow stream contacts each passage of the mixer/flow conditioner. The packets are then brought back together upon exiting the passages into a final flow stream characterized by a turbulent velocity profile having high shearing forces and vortex breakdown between and among the packets but controlled recirculation.

Preferably, the means for defining a plurality of passages in a corrugated strip. However, the invention should not be considered so limited as walls or structures that act as partitions could be used.

It is the orientation of a passage that determines if the passage gives a packet exiting the passage a tangential velocity component. More specifically, the orientation of a passage needed to give a tangential velocity component to a packet can be explained in the context of a standard x, y, and z coordinate system. In the case of the preferred embodiment, the successive partitions are generally cylindrical with the longitudinal axes of the partitions defining a common longitudinal axis. In a standard x, y and z coordinate system if the common longitudinal axis is the x coordinate (x being positive in the direction of flow of a packet through the passage) the orientation of the passage can be resolved into x, y and z coordinates. Wherein the orientation has a non-zero angle in the x-y plane (i.e. a non-zero y component), the passage will have an orientation that gives a packet exiting the passage a tangential component.

The invention is based upon establishing the orientation and size of the individual passages, by the physical characteristics of the passage, such that the sum of the angular momentum of the packets exiting the passages having an orientation is approximately zero, thereby giving a swirl number less than 0.6 or even below 0.3. As those skilled in the art of mixing and flow conditioning will appreciate if the sum of the angular momentum is zero, the swirl number will be zero. Therefore, the degree to which the sum of the angular momentum is non-zero will determine if the mixer/flow conditioner is a mixer and/or flow conditioner.

In another embodiment of the invention, intervening partitions are omitted. As discussed above, the invention uses successive partitions to create the gaps. In some applications, only two partitions may be required. In applications where most if not all the passages have an orientation and the orientation in each adjacent “gap” is opposite, the partition between the “gaps” might be eliminated.

In a mixing application of the mixer/flow conditioner, a fuel injector is positioned within the mixer/flow conditioner. The fuel injector is positioned to inject fuel immediately downstream of the mixer/flow condition, based on the normal flow of a fluid through the mixer/flow conditioner.

### DESCRIPTION OF THE DRAWINGS

FIG. 1 is a perspective view of a section taken on the diameter of the mixer/flow conditioner looking at the downstream face relative to the normal flow of a fluid therethrough;

FIG. 2 is a perspective view of the mixer/flow conditioner of FIG. 1 looking at the downstream side of the mixer flow conditioner with a fuel injector positioned in the center of the mixer/flow conditioner; and

FIG. 3 is a view of the downstream side of the mixer/flow conditioner of FIG. 1.

### DETAILED DESCRIPTION

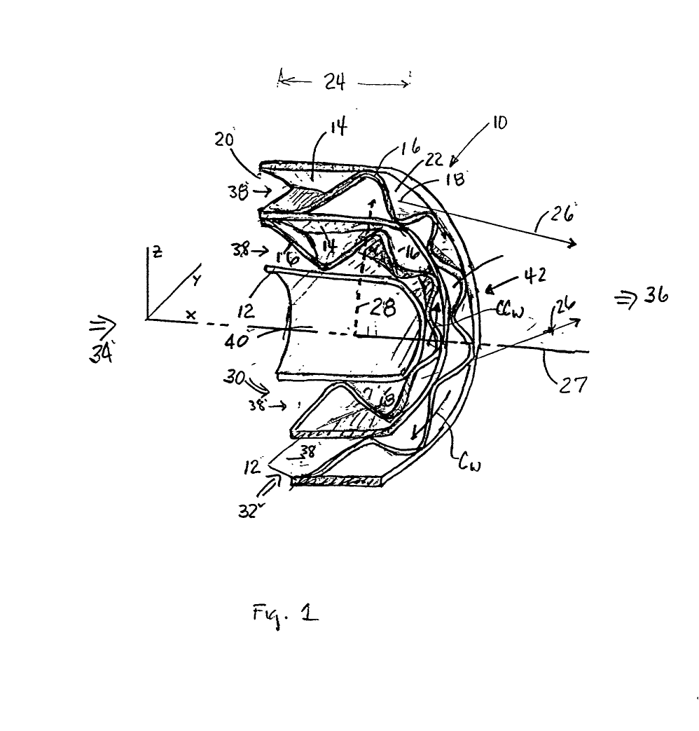

As shown in FIG. 1, a mixer/flow conditioner, generally referred to by the reference number 10, is comprised of three approximately concentric cylindrical partitions 12 successively positioned one inside the other. Each pair of successive partitions 12 defines a gap 14 therebetween. A strip 16 is positioned in each gap 14 and together with the partitions 12 defines a plurality of passages 18. Each passage 18 has an entrance 20, an exit 22, and a length 24. The orientation of the passages 18 is generally indicated by the arrows 26. Moreover, the location of each passage 18 relative to a central axis 27 is generally indicated by a position vector 28, taken perpendicular to the central axis 27.

In the illustrated embodiment, the passages 18 within a gap 14 are approximately of equal size (length, entrance hydraulic diameter (two times the cross-sectional area divided by the wetted perimeter), and exit hydraulic diameter) and shape. The passages 18 in inner gap 30 have an orientation indicated by the arrow 26 such that a fluid passing therethrough will be given a velocity component tangential to an circle defined by the position vector 28 thereby adopting a counter-clockwise rotation. The passages 18 in an outer gap 32 have an orientation indicated by arrow 26 such that a fluid passing therethrough will be given a velocity component tangential to a circle defined by the position vector 28 thereby adopting a clockwise rotation.

Whether an orientation 26 of passage 18 imparts a tangential velocity component is explained using a standard x, y, and z coordinate system, shown in FIG. 1 with the x axis positioned on the central axis 27. Any orientation 26 with a component resolvable into a y coordinate having a non-zero value is considered to impart a velocity component that is tangential. An individual passage 18 oriented such that that passage has no orientation with a resolvable component in the y coordinate, i.e. an angle only in the x-z plane, imparts no tangential velocity component to a packet passing therethrough.

The passages 18 of the inner gap 30 and outer gap 32 cooperate to convert an initial flow stream 34 into a final flow stream 36 having a turbulent profile and a swirl number (swirl number is equal to two times the axial flux of angular momentum divided by the product of the axial thrust and the swirler diameter) less than about 0.2 in the case of mixing and less than about 0.03 in the case of flow conditioning. Where the passages of two adjacent gaps work together such that the gaps taken as a unit produce the desired swirl number, the adjacent gaps are said to be working in pairs.

The passages 18 cooperate to produce a turbulent profile and the desired swirl number in the final flow stream 36, therefore, the characteristics of the passages 18 are determined as a unit. The degree of cooperation determines if the present invention is a mixer and/or flow conditioner.

In the case of the embodiment depicted in FIG. 1 this cooperation is achieved as follows. The passages 18 in a gap 14 are generally of the same size and orientation. Additionally, the passages 18 in the inner gap 30 and the outer gap 32 are generally of the same size with opposite but generally equal orientations. Therefore when an initial flow stream 30 encounters the mixer/flow conditioner 10, the initial flow stream 30 is broken down into a plurality of packets 38 (the portion of the flow stream 30 that enters a given passage 18), the packets 38 are of approximately the same mass and the mass of all the packets 38 within the inner gap 30 and the outer gap 32 are of approximately the same mass.

The passages 18, however, in the inner gap 30 and the outer gap 32 vary in tangential orientation 26, such that the packets 38 in the inner gap 30 upon exiting passages 18 have a counter-clockwise rotation and the packets 38 in the outer gap 32 have a clockwise rotation. Therefore, when a packet 38 exits a passage 18, the packet 38 leaves the passage 18 having a angular momentum (the cross product of a position vector of the passage 26, the mass of the packet, and the tangential velocity component of the packet 38). Depending upon which gap 14 the passage 18 is located in, the angular momentum is either positive or negative (based on an arbitrary assignment of clockwise or counter-clockwise as positive). Where the initial flow stream 30 has a uniform velocity profile, the sum of the angular momenta for all the exiting packets 38 is approximately equal to zero, thus achieving in a final flow stream 36 (the recombination of all packets 38) having the desired turbulent flow with the desired swirl number.

In the embodiment of the present invention, the partitions 12 are depicted as concentric rings and the strip 16 as a corrugated body. The strip 16 was made by passing a thin metal body through a set of offset gears. The present invention should not be considered so limited as it is not necessary that the partitions 12 be concentric nor that the passages 18 be defined by a single continuous thin metal body. The passages 18 could be defined by a plurality of walls. As shown in FIG. 1, the inner partition 12 defines a center 40 depicted as a hole, but it could also be a solid or have something such as a fuel injector positioned therein, as discussed below.

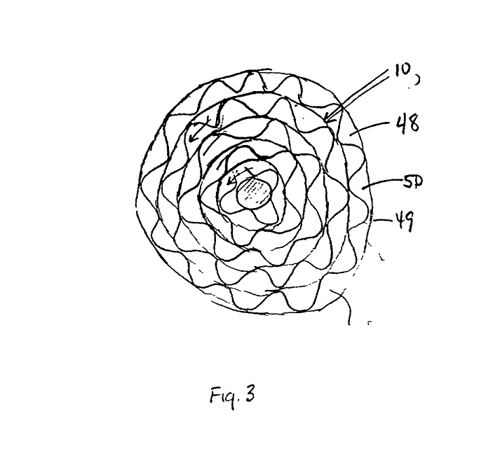

It is also not a limitation of the present device that gaps 14 act in pairs, nor that the sum of the angular momenta from any pair of gaps 14 equal zero. Other repeating units (see FIG. 3), other than pairs, are within the scope of the invention including repeating units such as of three gaps 14 where two gaps 14 are oriented in one direction and four gaps 14 where the two outer gaps 14 are oriented in one direction and the two inner gaps 14 are oriented in the other direction, or any combination of repeating units. While non-repeating units can be employed, repeating units are preferred. It is preferred, however, that any repeating unit produce an angular momentum approximately equal to the desired swirl number.

The passages 18 within a gap 14 or between gaps 14 do not have to be identical. The passages 18 can have different shapes and contours, and the invention should not be considered limited to passages 18 of the linear shapes depicted. The invention relies on offsetting angular momentum, therefore the invention only requires two passages 18 in two different gaps 14 with opposite orientations. Of course the two passages 18 would have to produce equal and opposite angular momentum and be positioned such that the two passages 18 could cooperate in a manner to allow the angular momentum to sum to near zero. In this case, if there were additional passages 18 in the mixer/flow conditioner, the remaining passages 18 would have no orientation that produced an angular momentum.

Each passage 18 entrance 20 defines a hydraulic diameter and the exits 22 define a downstream face 42. It is preferred the length 24 to the hydraulic diameter ratio range between a low of approximately 0.5 and a high of approximately 10. At a length 24 to hydraulic diameter ratio greater than 10, pressure drop becomes a significant issue. The orientation 26 tangential to the downstream face 42 of a passage 18, irrespective of clockwise or counter-clockwise, can range from just over zero degrees to 80 degrees (measured from the x axis in the x-y plane); if the orientation 26 were zero degrees there would be no tangential component. Two opposite orientations 26 can define an included angle that is the sum of the absolute value of the orientation 26 in the tangential direction between any pair of oppositely oriented passages 18. The included angle should be greater than about 15 degrees but less than about 60 degrees.

In a second embodiment of the device, the partitions 12 that are intermediate are omitted. As can be seen from FIG. 1, the strips 16 are corrugated and oriented such that if the intermediate partition 12 where removed the strips 16 would not nest.

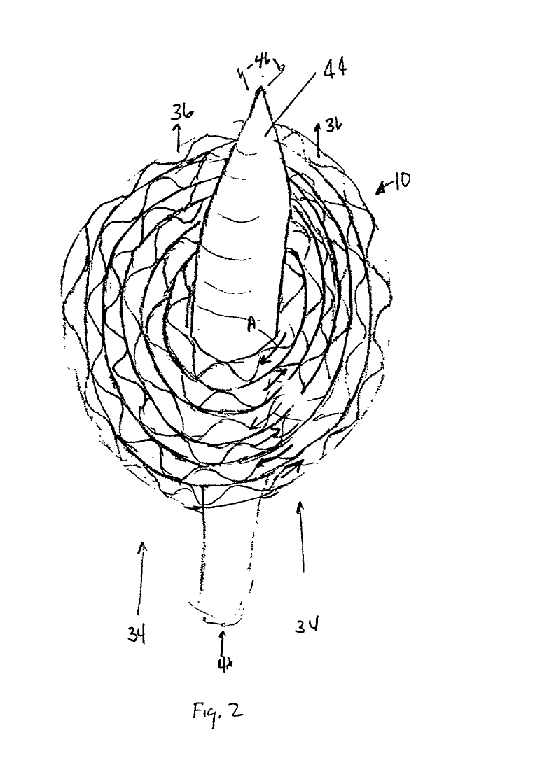

Referring to FIG. 2, a fuel injector 44 is placed in the center 40 of the mixer/flow conditioner 10 such that a fuel 46 exiting the fuel injector 44 is mixed with an initial flow stream 34, air, exiting the mixer/flow conditioner 10 as a final flow stream 36. Other bodies such as solid hubs can also be placed in the center. The fuel injector 44 is placed such that the mixer/flow conditioner 10 and the fuel injector 44 cooperate to mix the fuel 44 into the final flow stream 36.

FIG. 3 depicts the mixer/flow conditioner 10 with an additional outer gap 48 defined by a wall 49. The outer gap 48 has channels 50 oriented (same as defined for passages above) such that a fluid passing therethrough exits generally without a tangential velocity component (i.e. no y coordinate in the velocity). The wall 49 and channels 50 are formed in a similar manner as the partitions 12 and passages 18, respectively, in the mixer/flow conditioner 10. In some applications, where flashback or autoignition is a concern, an orientation of the channels 50 near zero in the outer most gap 48 will lessen the potential of a dead zone at the interface of the device and a housing (not shown), such as a pipe, in which it is positioned.

Although the present invention has been described in considerable detail with reference to certain preferred versions thereof, other versions are possible. Therefore, the spirit and scope of the invention should not be limited to the description of the preferred versions contained herein.

What is claimed is:

1. A mixer/flow conditioner comprising:
at least three successive partitions defining at least two gaps therebetween;
means within each gap defining a plurality of passages, at least one passage in each gap being oriented to impart a tangential velocity component to a packet passing therethrough; and wherein
the at least one passages cooperate to convert an initial flow stream into a final flow stream having a swirl number less than about 0.2.

2. The mixer/flow conditioner of claim 1 wherein the means within each gap for defining a plurality of passages is a corrugated strip.

3. The mixer/flow conditioner of claim 1 wherein the swirl number is less than about 0.03.

4. The mixer/flow conditioner of claim 3 wherein the swirl number is less than about 0.02.

5. The mixer/flow conditioner of claim 1 wherein the plurality of passages each have an exit defining a hydraulic diameter and a length and the passages within an individual gap have an equal length to hydraulic diameter ratio.

6. The mixer/flow conditioner of claim 5 wherein the passages in adjacent gaps have orientations that are opposite each other whereby the passages in one gap impart a clockwise swirl and the passages in the other gap impart a counter-clockwise swirl.

7. The mixer/flow conditioner of claim 5 wherein the orientation of the passages within an individual gap are identical.

8. The mixer/flow conditioner of claim 7 wherein the passages in adjacent gaps have orientations that are opposite each other whereby the passages in one gap impart a clockwise swirl and the passages in the other gap impart a counter-clockwise swirl.

9. The mixer/flow conditioner of claim 5 wherein all the passages have an orientation.

10. The mixer/flow conditioner of claim 1 wherein the partitions are approximately concentric.

11. The mixer/flow conditioner of claim 10 wherein there are at least 6 gaps.

12. The mixer/flow conditioner of claim 10 wherein adjacent gaps act as pairs.

13. The mixer/flow conditioner of claim 1 wherein the orientation of the passages is less than about 80 degrees relative to the central axis.

14. The mixer/flow conditioner of claim 13 wherein the orientation of the passages in two adjacent gaps defines an included angle between 15 and 60 degrees.

15. The mixer/flow conditioner of claim 13 wherein the passage has a length and an exit defining a hydraulic diameter, and the passages having a length to hydraulic diameter ratio less than about 10.

16. The mixer/flow conditioner of claim 15 wherein the length to hydraulic diameter ratio is greater than about 0.5.

17. The mixer/flow conditioner of claim 1 further comprising an outer gap having means for defining channels wherein the channels have an orientation that generally only has an x component.

18. A mixer/flow conditioner for conditioning comprising:
at least two partitions defining a gap;
at least two corrugated strips positioned in the gap, each strip defining a plurality of passages, each passage having an orientation; and wherein
the passages cooperating to produce a swirl number less than 0.2.

19. The mixer/flow conditioner of claim 18 wherein the swirl number is less than 0.03.

20. The mixer flow conditioner of claim 19 wherein the swirl number is less than 0.02.

21. The mixer/flow conditioner of claim 18 wherein the plurality of passages each have an exit defining a hydraulic diameter and a length and the passages within an individual gap have an equal length to hydraulic diameter ratio.

22. The mixer/flow conditioner of claim 21 the passages in adjacent gaps have orientations that are opposite each other whereby the passages in one gap impart a clockwise swirl and the passages in the other gap impart a counter-clockwise swirl.

23. The mixer/flow conditioner of claim 22 wherein the gaps are concentric.

24. The mixer/flow conditioner of claim 23 wherein the gaps act in pairs.

25. The mixer/flow conditioner of claim 24 wherein the orientation of adjacent gaps is opposite one to the other and the sum of the angular momenta of the packets exiting the passages of adjacent gaps are equal to about zero.

26. The mixer/flow conditioner of claim 25 wherein there are at least 6 gaps.

27. The mixer/flow conditioner of claim 18 wherein the orientation is less than about 80 degrees relative to the central axis.

28. The mixer/flow conditioner of claim 27 wherein the orientation of two adjacent gaps defines an included angle between 15 and 60 degrees.

29. The mixer/flow conditioner of claim 27 wherein each passage has an exit defining a hydraulic diameter and a length, and the length to hydraulic diameter ratio is less than 10.

30. The mixer/flow conditioner of claim 29 wherein the length to diameter ratio is greater than 0.5.

31. The mixer/flow conditioner of claim 30 wherein the orientation of the passages within a gap are identical.

32. The mixer/flow conditioner of claim 18 further comprising an outer gap having means for defining channels wherein the channels have an orientation that generally only has an x component.
